(19) United States
(12) Patent Application Publication
(10) Pub. No.: US 2005/0183254 A1
(43) Pub. Date: Aug. 25, 2005

(54) Threading attachment for automatic lathes

(76) Inventor: Peter Christopher Frow, Gillitts (ZA)

Correspondence Address: YOUNG & THOMPSON, 745 SOUTH 23RD STREET, 2ND FLOOR, ARLINGTON, VA, 22202, US

(21) Appl. No.: 11/047,707

(22) Filed: Feb. 2, 2005

Related U.S. Application Data
(63) Continuation of application No. PCT/ZA03/00104, filed on Aug. 1, 2003.

(30) Foreign Application Priority Data
Aug. 2, 2002 (ZA) 2002/6158

(51) Int. Cl. B23B 25/00

(52) U.S. Cl. 29/27 C

(57) ABSTRACT

An attachment for an automatic lathe (10) and which is capable of carrying out threading operations without the need for purpose made cams; the attachment having a pair of quills (30, 34), one (30) holding a drill bit (32) and the other (34) a threading bit (36), with means such as cams (52, 90), for interchanging the quills (30, 34) precisely with respect to a work piece. (14). The interchange of the quills (30, 34) and operation of the threading bit (36) are predetermined

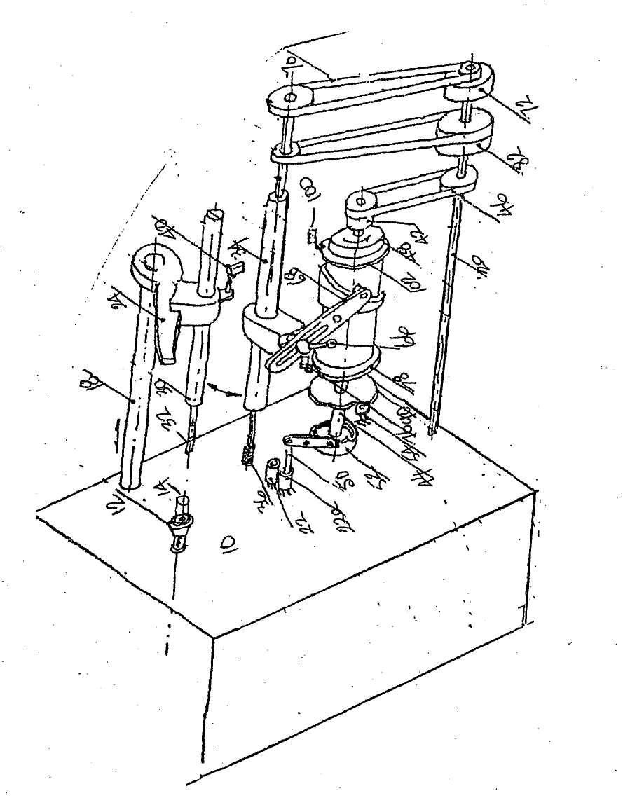

### TECHNICAL FIELD OF THE INVENTION

This invention relates to a threading attachment for an automatic lathe.

### BACKGROUND ART

Conventional cam-operated lathes for threading operations rely on a purpose made cam for advancing and retracting the threading burr. Each different component requires such a cam which must be carefully designed by an expert, accurately made by a cam manufacturer and then fitted and properly timed by a competent toolsetter.

In addition the indexing to and from the threading station involves the setting of trip dogs and in many cases the design, manufacture and setting of a flier purpose-made cam.

Any alteration in the spindle speed, or cycle time of the lathe will affect the proper functioning of this threading process and may well require the redesign and remanufacture of the cams.

It is an object of the present invention to avoid the need for purpose-made cams and other integers.

### DISCLOSURE OF THE INVENTION

According to the invention a lathe arrangement includes a pair of quills contained within a rocking tailstock, the first one adapted to hold a drill bit or other cutting tool and the second adapted to hold a threading bit, the quills being movable to and form their working positions, a spindle for a work piece and a driving shaft,
the driving shaft being rotatable at a rate proportional to the rate of rotation of the spindle;
and being adapted to drive a camshaft contained within the rocking tailstock when the quill holding the drill bit has reached a predetermined rearward position disengaged from the work piece;
the camshaft including clutch means to engage the second quill to rotate it at a speed slower than that of the work piece and spindle, the rate of advance of this quill being determined by an adjustor element;
the camshaft including means to increase the rate of rotation of the second quill to a value greater than that of the work piece spindle in order to screw the threading bit out of the work piece, and
means to return the first quill to its working position once the threading operation is complete.

In a preferred form of the invention the first quill is caused to complete its drilling function and to move away from the work piece and to actuate a switch at a predetermined position, the switch causing the cam shaft to rotate at a rate proportional to the workpiece spindle. This action of the camshaft results in the first quill being removed from its working axis and the second quill being moved into its working axis with respect to the work piece; the initial rate of rotation of the second quill is slower than the workpiece spindle in order to cut a desired thread, at the end of which operation a cam on the camshaft actuates a switch which causes the drive to be changed to a rate higher than that of the spindle so that the threading tool is screwed out of the work piece.

Once removed from the work-piece the original rate of rotation is regained by activation of a switch (by a cam on the camshaft), so that the second quill can be moved from its working axis and replaced by the first quill to commence the next operation.

The exact location of the quills on their working axes may be ensured by means of an indexing pin contained within the rocking tailstock locating in accurately positioned bushes in the main frame of the lathe.

The driving shaft not only drives the camshaft but also the shaft holding the second quill by means of a plurality of belt or other drives which arm easily selected for use by engaging or disengaging clutches associated therewith.

The adjuster element is mounted in the rocking tailstock and includes an arm with a slot which carries a wing nut or the like for setting at the correct ratio to provide the appropriate rate of advance of the threading burr depending on the pitch of thread required.

Apart from the shaft for the first quill, its actuating arm, the lathe, spindle and the bushes referred to above all components are carried on or within a rocking tail stock.

The camshaft may include means to limit the rotation to only one revolution of the camshaft for each threading sequence.

The camshaft may include a cam for controlling and adjusting the axial movement of the second quill. Thus, the axial movement rate of the rotating threading quill may be varied to allow the cutting of threads of different pitches.

It will be appreciated that the arrangement of the present invention allows the production of a wide variety of threads both internal and external without the need for designing, changing and setting of cams as was the case in the prior art. In addition because all motions occur at a rate proportional to the speed of the workpiece spindle, the device will function correctly even when the speed of this spindle is altered.

### BRIEF DESCRIPTION OF THE DRAWINGS

An embodiment of the invention is described below with reference to the accompanying drawing which is an isometric diagrammatic representation of the essential integers of the lathe according to the invention.

### BEST MODE FOR CARRYING OUT THE INVENTION

In the drawing a lathe 10 may be cam-operated and has a spindle 12 for holding a work piece 14 and a means, preferably a cam, for moving a shaft 18.

In addition the lathe drives a rotating shaft 20 at a rate proportional to that of the spindle 12.

All of the components shown in the drawing, with the exception of the bushes 22, 22a, the actuating shaft 18, an actuating arm 24, and the lathe 10 with its spindle 12, are carried by a rocking tail stock (not shown for reasons of clarity of the essential integers). This tail stock is caused to rock to and fro and is pivoted about the shaft 20 so that quill 30 (for the drill bit 32) and 34 (for the threader bit 36) may be alternately aligned with and presented to the work piece.

The operation of the lathe comprises the following sequence:
a. Quill 30 carrying a drill bit 32 or other cutting tool returns to its rearmost position having completed its work, and in so doing activates switch 40.
b. Switch 40 activates clutch 42 such that camshaft 44 begins to rotate being driven via belt drive 46, clutch 42, and the reduction gearbox 48.
c. Indexing bolt 50 is withdrawn from locating bush 22a by means of cam 52.
d. Rocking tailstock is caused to rock by means of cam 90 acting against roller 54 fixed to frame of lathes such that rotating quill 34 is moved into alignment with spindle 12.
e. Indexing bolt is allowed by cam 52 to drop into locating bush 22.
f. Rotating quill 34 is moved axially toward workpiece at a rate appropriate to the thread being cut, this rate being set by means of the pitch adjuster element 66 on ratio arm 68. At this stage, the tap 36 or other threading tool is being rotated at a speed somewhat slower than that of the spindle 12 by means of belt drive 70 driven through clutch 72. This differential rotation will tend to screw a right-handed threading tool into the workpiece thus causing a thread to be cut.
g. When the threading tool has reached the required depth, switch 76 is activated by cam 78 causing clutch 72 to be disengaged and clutch 82 to be engaged. This causes the speed of the rotating quill 34 to increase to a speed higher than that of spindle 12 such that the differential rotation will now tend to screw the threading tool out of the workpiece.
h. When the threading tool has been extracted from the workpiece, and the rotating quill has returned to its rearmost position, switch 76 is de-activated thus de-activating clutch 82 and activating clutch 72 such that the rotating quill returns to its slower speed.
i. The indexing bolt 50 is withdrawn from locating bush 22 and the rocking tailstock is caused to rock back by means of cam 90 acting on roller 54 until quill 30 is once again in line with spindle 12.
j. Indexing bolt 50 is allowed by cam 52 to drop into locating bush 22a.
k. Switch 100 drops into notch on cam 102 which causes clutch 42 to be de-activated thus stopping the rotation of camshaft 44 and completing the threading sequence.

It will be appreciated that the present invention
a. Obviates the need for cams to be designed, made or fitted. The device incorporates universal cams suitable for a wide range of components and threads both internal and external.
b. No timing is involved as all events are pre-timed as factory settings and the threading sequence is automatically triggered on completion of the previous drilling or turning operation.
c. The device is unaffected by changes in spindle speed and cycle time as it operation is synchronised with the rotation of the main late spindle.

1. A lathe attachment including a pair of quills contained within a rocking tailstock, the first one adapted to hold a drill bit or other cutting tool and the second adapted to hold a threading bit, the quills being movable to and from their working positions, a spindle for a work piece and a driving shaft, characterised in that the driving shaft being rotatable at a rate proportional to the rate of rotation of the spindle; and being adapted to drive a camshaft contained within the rocking tailstock when the quill holding the drill bit has reached a predetermined rearward position disengaged from the work piece, the driving shaft including clutch means to engage the second quill to rotate it at a speed slower than that of the work piece spindle, the rate of advance being determined by an adjuster element, the camshaft including means to increase the rate of rotation to a value greater than that of the work piece spindle in order to screw the threading bit out of the work piece, and means to return the first quill to its working position once the threading operation is complete.

2. The lathe arrangement according to claim 1, characterised in that the first quill is caused to complete its drilling function and to move away from the work piece and to actuate a switch at a predetermined position, the switch causing the cam shaft to rotate at a rate proportional to the work piece spindle, such action of the camshaft resulting in the first quill being removed from its working axis and the second quill being moved into its working axis with respect to the work piece, the initial rate of rotation being slower than that of the work piece spindle in order to cut a desired thread, at the end of which operation a cam on the camshaft actuates a switch which causes the drive to be changed to a rate higher than that of the spindle so that the threading tool is screwed out of the work piece.

3. The lathe arrangement according to claim 2 characterised in that once removed from the work-piece the original rate of rotation is regained by activation of a switch by a cam on the camshaft so that the second quill can be moved from its working axis and replaced by the first quill to commence the next operation.

4. The lathe arrangement according to claim 1 characterised in that the exact location of the quills on their working axes is ensured by means of an indexing pin contained within the rocking railstock locating in accurately positioned bushes in the main frame of the lathe.

5. The lathe arrangement according to claim 1 characterised in that the driving shaft not only drives the camshaft but also the shaft holding the second quill by means of a plurality of belt or other drives which are easily selected for use by engaging or disengaging clutches associated therewith.

6. The lathe arrangement according to claim 1 characterised in that the adjuster element is mounted in the rocking tailstock and includes an arm with a slot which carries a wing nut or the like for setting at the correct ratio to provide the appropriate rate of advance of the threading tool depending on the pitch of thread required.

7. The lathe arrangement according to claim 1 characterised in that the components, other than the shaft for the first quill, its actuating arm, the lathe, spindle and the bushes referred to above are all be carried within the rocking tail stock.

8. The lathe arrangement according to claim 1 characterised in that the camshaft includes means to limit the rotation to only one revolution of the camshaft for each threading sequence.
